(19) United States
(12) Patent Application Publication
(10) Pub. No.: US 2020/0043453 A1
(43) Pub. Date: Feb. 6, 2020

(54) MULTIPLE AUDIO TRACK RECORDING AND PLAYBACK SYSTEM

(71) Applicant: MUSIC Tribe Global Brands Ltd., Road Town (VG)

(72) Inventors: Thomas A. LANG, Victoria (CA); Yan LI, Victoria (CA)

(21) Appl. No.: 16/052,931

(22) Filed: Aug. 2, 2018

(51) Int. Cl. G10H 1/40; G10H 1/00

(52) U.S. Cl. CPC G10H 1/40; G10H 1/0008; G10H 2210/076; G10H 2210/071; G10H 1/0066

(57) ABSTRACT

A multiple audio track recording and playback system having at least two audio inputs, a first audio input for receipt and recording of audio tracks AT representing a first audio stream, a second audio input for receipt of a second audio stream, the system is configured for playback of audio tracks recorded on the basis of the first audio stream and the playback is performed with reference to a tempo reference, the tempo reference is automatically derived from beats obtained through beat detection, and the system is configured for beat detection on the basis of at least the first audio stream and the second audio stream.

### BACKGROUND

### Technical Field

The present disclosure relates to a multiple audio track recording and playback system and, more particularly, to a system and method for the playback of an audio signal in conjunction with a detected beat tempo.

### Description of the Related Art

The present disclosure pertains to live musical performances. Specifically, the present disclosure pertains to real-time looping and loop playback, wherein a musician performs a musical phrase that is recorded by the looping device, then played back repeatedly while the musician performs a complementary piece of music over top of the recorded loop. If a guitarist wishes to play a loop, then layer another part overtop of the loop such as a solo or complementary rhythm part, the guitarist and the rest of the band must precisely follow the loop and its tempo. Following a loop with precision can be challenging if the monitor setup for the other band members is anything less than excellent, or if anyone's timing within the group is slightly off-beat. An inadequate monitoring situation or slight timing error could easily lead to the band losing track of the loop tempo, thereby degrading the quality of their performance, perhaps catastrophically.

### BRIEF SUMMARY

The present disclosure relates to a multiple audio track recording and playback system (RPS) and related method. The system includes at least two audio inputs, a first audio input (FAI) for receipt and recording of audio tracks AT representing a first audio stream (FAS), and a second audio input (SAI) for receipt of a second audio stream (SAS), wherein the system is configured for playback of audio tracks (AT) recorded on the basis of the first audio stream (FAS) and wherein the playback is performed with reference to a tempo reference (TR), and wherein the tempo reference (TR) is automatically derived from beats obtained through beat detection (BD), and wherein the system is configured for beat detection on the basis of at least the first audio stream and the second audio stream.

Using both the first and the second audio stream as a source for beat detection provides the user with a unique option of recording and playing audio material, which is particularly attractive in loopers because both the first and the second audio input may influence the tempo of the playback of the recorded audio tracks. This will make it possible to establish a base layer of a recorded audio track that serves as a basis for beat detection, and then switching the source of beat detection to the second audio input. The second audio input may then be subsequently used as a source for beat detection. This makes it possible to provide a looper that is dynamic and completely different from any device provided on the market.

The beat detection may be performed on the second input stream as the second input stream is preferably serving as a tempo reference for the audio tracks recorded from the first audio input.

The beat detection related to the first audio input may both be performed on a stored and recorded audio track received through the first audio input, but it may also be performed on the fly while receiving the audio stream, either pre-recorded or live audio stream. Either way, the beat detection is understood to be performed on the basis of the first audio stream, recorded or not.

The beat detection may, according to the disclosure, typically be performed on the basis of both the first and the second audio streams during operation of the system, i.e., during playback or recording or both. It should nevertheless be stressed that the system may automatically or manually choose between the first and the second audio stream as a source for a resulting modification of the tempo reference. In other words, beat detection may be performed on both streams, but the system may choose to use only use beat detection from either the first audio stream or the second audio stream as a basis for an automatic modification of tempo reference and a subsequent playback with reference to the same.

The systems according to the provisions of the disclosure may in advantageous implementations be applied as a stand-alone device, such as an audio pedal. The stand-alone device would, thus, include the first and second inputs, an output, and the required hardware and software for executing the desired functionality.

Playback of audio tracks recorded on the basis of the first audio stream with reference to a tempo reference simply means that the first audio stream is recorded by the system and the playback is then performed with reference to a tempo reference. The tempo reference may, within the scope of the disclosure, be broadly understood as a tempo reference defined with reference to musical references.

A way of representing the tempo within the scope of the disclosure is by beats-per-minutes (BPM) of the audio sound from instruments or vocals or both. Musical tempo notation may of course be supplemented with more detailed time references such as SMPTE timecode, absolute time references, reference to musical notations as an add on to tempo reference, such as time signature, location of beats with reference to specific expected bars/measures, etc.

In the present context, beat detection is executed automatically using computer software on computing hardware to detect the beat of an audio signal. This audio signal may comprise recorded audio tracks, e.g., an audio track recorded on the basis of first audio stream, or it may be the first audio stream itself. The audio signal being a source for beat detection may also be the second audio stream. The signal may, if desired, be stored, but it may not be necessary to do that as long as the detected beats are registered in order to affect the playback of the recorded audio tracks based on the first audio stream.

Beat detection is always a tradeoff between accuracy and speed. Beat detectors are common in music visualization software such as some media player plugins. Beat detection may also be used in musical sequencers where beat detection in audio is used as a basis for correction, or rather synchronization, with a given tempo reference. If a beat of a recorded audio signal is registered and it is determined that the beat is out of sync with the intended beat, this beat may be corrected manually or automatically with reference to a time reference.

The algorithms used may utilize statistical models based on sound energy or may involve sophisticated comb filter networks or other means. In the present context, it is desired that the algorithms are fast, thereby enabling an on-the fly-beat detection and, consequently, an on-the-fly time stretching of recorded audio tracks to adapt the recorded audio tracks to either one or some of the recorded tracks, or adapt the recorded audio tracks to the second audio stream.

It should be noted that beat detection may also be referred to beat tracking within the musical art, and algorithms are available to the skilled person for that purpose.

The second audio stream may then be used for beat detection and then be used to modify the playback of the recorded audio tracks.

It should be noted that modification of the playback of the recorded audio tracks may be directly obtained by modification of the recorded audio tracks as recorded and stored in the system. The modification may also be obtained through a modification of the audio track during playback, i.e., without affecting modifying of what has been recorded.

The first audio input is as indicated above dedicated for receipt of a first audio stream which is intended for recording in the system and subsequent playback.

The disclosure is, thus, advantageous in relation to resolving a problem extant in live performance situations, namely that unless a band is playing along to an in-ear metronome click or a tempo guide such as a MIDI track, the performance tempo will fluctuate throughout the song.

The present disclosure facilitates looping for bands that are not using a click track or similar tempo guide technology such as a MIDI clock, or for bands that are not equipped with in-ear monitors for every member. This product may preferably be portable, elegant, and require no special technical knowledge or equipment beyond the device itself to achieve maximum functionality.

In an implementation of the disclosure, the system is configured for playback of audio tracks (AT) recorded on the basis of the first audio stream (FAS) wherein the playback is performed with reference to the tempo reference (TR) and location of the detected beats.

According to an implementation of the disclosure, playback of the audio tracks will be made with reference to both the tempo reference and the specific locations of the detected beats. This may help not only to estimate the tempo, but also consider style, grooves, and time signature/measure, and it is thereby also possible to use the detected beats for predicting beat locations.

In an implementation of the disclosure, the system is configured for marking detected beats of at least one of the recorded audio tracks, thereby establishing a beat reference (BM1, BM2, BM3, BMn)) related to the relevant audio track

Preferably, the base layer should be marked with beat locations, thereby providing the benefit that a subsequent beat detection, e.g., based on the second audio stream, may easily serve as a basis for on-the-fly synchronization with the base layer. In this way, beat detection can be performed on the fly on, e.g., the further audio stream, and once beat detections has been established, the base layer may be synchronized with reference to the second audio stream by adjusting the beats of the base layer to match, of course more or less accurately, to the beats detected in the second audio stream. Such an adjusting may, for example, be that the audio of the base layer is time stretched to match the tempo or beat controlling a further audio stream.

According to a preferred implementation, it would typically be the second audio stream which is regarded as a primary source for tempo controlling. It would nevertheless also be possible that a recorded layer, not necessarily the base layer, could serve as a basis for beat detection and a subsequent time stretching of other audio tracks.

In an implementation of the disclosure of the system, the playback performed with reference to a tempo reference involves recorded audio tracks that are synchronized to the first or the second audio stream by time stretching.

Time stretching is a well-known functionality and different approaches are known within the art. Time stretching involves the process of changing the speed or duration of an audio signal without affecting its pitch. Time stretching may be performed, for example, on the basis of resampling, a frame based approach, a frequency domain approach, or a time-domain approach.

An applicable time stretching algorithm is phase vocoder based, as this is suited for polyphonic time stretching.

In an implementation of the disclosure, the multiple audio track recording and playback system comprises a system output (SO) for playback of recorded audio tracks.

The system may preferably include a mixer for mixing and subsequent playback at the system output. The system output may be analog or digital. The system output may, in some applications, be formed by female XLR or jack outputs, preferably in stereo, thereby enabling a user to connect with typical public address systems, thus allowing amplification and rending of the outputted playback audio signal.

In an implementation of the disclosure, the system is configured for recording of audio tracks via the first audio input (FAI), and the recording is performed according to a user controlled looper algorithm (LA) implemented by computing hardware of the system, the looper algorithm (LA) enabling a recording of an audio track and designating this audio track functionally as a base layer (BL), the looper algorithm (LA) further enabling the recording of a further audio track via the first audio input (FAI) and designating this further audio track functionally as an overdub layer, the looper algorithm further enabling simultaneous playback of both the base layer and the overdub layer.

The playback of both the base layer and the overdub layer may, preferably, be fed to the system output (SO), preferably as a mix.

In an implementation of the disclosure, the first audio input (FAI) is provided as an instrument input.

The first audio input is used as an input for recording, and the system therefore typically includes an analog small-signal amplifier if the input is designed for receipt of an analog signal from and instrument or from a microphone. It is, of course, also possible within the scope of the input that the first input is a digital audio, electrical, or optical input. Such interfacing technologies are known within the art.

In an implementation of the disclosure, the second audio input (SAI) is provided as an input for ambient sound.

The ambient sound may advantageously be the primary source of the tempo/beat detection. This is because the goal is to synchronize the loop with the band. However, there are cases where the ambient sound does not contain enough information to extract tempo and beats, for example, the user is playing alone, the guitar amp is too loud and masking other instruments, or simply beats extracted from ambient sound have low confidence. Then the first audio stream, e.g., an instrument input, is considered in the beat detection.

The second audio input may serve as an input for ambient sound in different ways. The system may, thus, include a connector for a microphone socket, e.g., a standard XLR plug, whereby a user may, in a conventional way, apply a cabled microphone as a source for the second audio signal. The second audio signal is, thus, a further, and typically different, audio stream than the audio stream received and optionally recorded at the first audio input. The present disclosure may also refer to the second audio stream as an ambient signal, thereby indicating that the relevant signal is there for the system to listen to, rather than for recording. It goes without saying that any input suitable for the purpose may be applied within the scope of the disclosure and this also includes digital interfacing technologies.

Overall, the first audio stream and the second audio stream may be regarded as two different types of control signals which may influence the tempo of the playback of the recorded material.

In an implementation of the disclosure, the system (RPS) is configured as a stand-alone device comprising the first audio input (FAI), and the device further comprises an on-board microphone arrangement communicatively coupled with the second audio input (SAI), and the device further comprises the system output (SO).

The inclusion of a complete audio detection arrangement in relation to the second audio stream by the provision of a stand-alone device including a microphone arrangement provides a very attractive and practical musical application. A user such as a musician may, therefore, set up the system simply by plugging the instrument to be recorded, e.g., a guitar, into the first audio input, plugging the output of the device into the PA system (public address system), and connecting an optional external power source. Then the system may be running.

A musician may, thus, use the device as a listening looper with little effort and few weak points, such as further cable connections, which may be defective or provide further messy arrangements on a stage. The device is easy to plug-and-play.

In an implementation of the disclosure, the microphone arrangement is communicatively coupled with signal processing circuitry of the device, and the signal processing circuitry is configured to enhance or suppress sound from a certain direction.

By configuring the device for suppressing or enhancing of sound from a certain direction, it is thereby possible to provide a second audio stream which may be less interfered or contaminated by audio which does not provide the desired beat guidance. Such contamination may be present, for example, if the device is operated by a guitarist whose guitar amplifier or on-stage monitor has a high level of the guitar, thereby effectively masking a desired ambient beat defining instrument, typically the drums. By making the detection effectively directional it is, thus, possible to obtain a device which automatically focusses on the ambient sound which is of most relevance for the ambient beat detection.

The microphone array may be omnidirectional or directional as long as it makes it possible to enhance or suppress sound from a certain direction.

More than two microphones can also be used.

In an implementation of the disclosure, the source for beat detection is partly the first audio stream and partly the second audio stream and/or the second audio stream serves as the primary source for beat detection.

In an implementation of the disclosure, the system comprises a user interface configured for manually switching between the first audio stream, or a signal derived therefrom, and the second audio stream as the principle source for automatic beat detection.

The user interface may comprise a simple selector by means of which a user can manually choose the preferred source of beat detection. This may enable the user to select the current first audio stream or recorded audio tracks as source for beat detection, e.g., when recording the base layer, and thereby enable an automatic beat detection on what is actually played and recorded.

The user may then subsequently switch to the second audio stream as a source for beat detection, thereby enabling that playback may be adapted to a stronger source of beat detection registered by the second non-looped audio stream.

In an implementation of the disclosure, a confidence algorithm automatically establishes a confidence estimate (CE) related to the first audio stream and the second audio stream, and the tempo reference (TR) is automatically derived from the audio stream on the basis of the established confidence estimate.

The system will, in the present implementation of the disclosure, thus automatically establish a confidence estimate related to the first and the second audio streams and then automatically choose one of the audio streams as the best audio stream for control the playback tempo.

It is also possible within the scope of the disclosure to analyze sub-periods of a loop period, thereby switching between two audio streams, or even two audio tracks related to the first audio stream during a loop period.

It should be noted that the present disclosure facilitates the use of hinting, which is very attractive and unique in relation to looping. Tapping for setting a tempo in relation to musical applications is well known, but a user may, according to an implementation of the disclosure, simply do a traditional tapping on the device or the system by hand or foot and then either force or hint a suitable tempo for the playback when registering the hinting typically by means of the second non-recorded audio stream. This is different from traditional tapping in the sense that traditional tapping would typically be a forced tempo setting whereas the present disclosure may simply hint a playback tempo, and then the confidence algorithm may analyze the audio streams, including the audio stream in which the hinting is induced, and then determine whether the hinted tempo is better in quality than the tempo derived from the first audio stream. If it is better, the algorithm may synchronize with the hinted tempo or the algorithm may, alternatively, use another source for tempo reference.

A user may correct the beat tracking in real time by means this tapping or hinting. The tapped beats are considered ground truth. Then the beat detection algorithm is “trained” in real time to make better detection and prediction. A simpler version would be just to use the tapped beats as true beats.

The user may, thus, obtain a real-time correction or correctness of the playback of the loop if the playback loses synchronism. In other words, instead of being embarrassed by a looper which has basically lost a true tempo reference, a musician may assist the looper to find the beat of the ambient music on the fly, while music is playing.

In an implementation of the disclosure, the tempo of playback is established on the basis of beat detection of both audio recorded by the first audio input and audio received via the second audio input during playback.

In an implementation of the disclosure, the system comprises a user interface configured for user determination of a loop period, and this loop period is preferably defined by a setting the period of the base layer.

A user interface configured for user determination of a loop period may, in a simple version, either be a one or two-button interface, by means of which a user can manually initiate recording of the first audio stream and stop the recording again, therefore in time defining the base layer and thereby also the loop period at which subsequent playbacks of the base layer is repeated.

The recording of audio tracks, e.g., a base layer or subsequent overdub layers, may be configured to be more or less automatic, but it is preferred that a user, e.g., a musician, by means of suitable system interface, is able to start and stop a recording of a track based on the first audio stream. The system interface should, thus, make the user able to establish and record a base layer as an audio track which may subsequently be played back, e.g., repeated via a system output.

The system interface may optionally, and preferably, also include an option for creation of overdub layers, i.e., further audio tracks, which may be replayed in synchronization with the base layer. Such a replay would preferably require that the system includes an output mixer feeding the system output with a mix of the relevant recorded audio tracks, typically a base layer and one or more overdub layers.

The system interface may advantageously further include options for manual modification/deletion of a base layer or overdub layers during a session.

According to an implementation of the disclosure, it is, thus, possible to perform a playback of audio where the tempo is set on the basis of both a recorded audio track and a further audio input, e.g., input received from an ambient microphone input. The use of a two-channel input of beat detection makes it possible for the system to modify the tempo of the playback according to what has been, or what is being, recorded by the first audio input, but it is also possible to use the second audio input as a source for tempo modification of the playback.

In an implementation of the disclosure, the system further comprises a display arrangement by means of which the quality of the beat detection in relation to the first and second audio stream is indicated visually.

The display arrangement may, as such, be a high-resolution display, but may also be a low resolution display by means of one or few dedicated or multipurpose LEDs.

An LED dedicated to the first audio stream, i.e., the audio stream recorded, may thus indicate, by simple on/off colors such as red and green, whether beat detection is considered valid or stable. Another LED may be dedicated to the second audio stream and also indicate, by simple on/off colors such as red and green, whether beat detection is considered valid or stable.

A visual indication of the quality of the beat detection in relation to either the first audio stream or the second audio stream may, thus, form an effective tool for a user of the system, implemented in a device or not.

The visual indication may be used during playing and show in a clear manner to the user that it might be wise to hint the tempo to the device if synchronism is either lost or at risk of being lost.

In an alternative application, the device may facilitate an easy setup of the system, e.g., as a stand-alone device, by means of which a user may modify the position of the system/device, or modify the position of an external microphone connected to the system, in order to provide a solid setup where a solid tempo reference may be expected, in particular in relation to the second audio stream.

In an implementation of the disclosure, the system comprises a MIDI output, and the MIDI signal fed to the MIDI output reflects the current tempo reference.

By interfacing the current tempo reference used as a basis for playback, the system may thereby be interfaced with other musical gear. This could include, for example, effects such as delays, which may then be used as a source for modifying the delay or effect when the tempo reference is changing based on beat detection either obtained via the first or second audio stream.

Other effects may also be made dependent on the established a varying time reference.

The system may also include a MIDI audio input, by means of which the system may undergo external control if so desired. The MIDI input may, in principle, also be used as a further input which may be used in the same way as the first and second audio streams, namely to detect beats and thereby establish tempo references or beat positions for the purpose of controlling the playback of recorded audio tracks.

The system may, of course, also include a by-pass by means of which a user of the system may by-pass the system.

In an implementation of the disclosure the system comprises at least one further audio input (FURAI) for receipt of a further audio stream (FUAS) and whereby the tempo reference (TR) is based on the first audio stream, the second audio stream, and the at least one further audio stream (FUAS).

The disclosure further relates to a method of establishing a variable tempo of a musical looper, wherein playback of the looper is performed with reference to a tempo reference TR, the tempo reference being variable and dependent on beat detection performed with reference to at least two separate audio streams (FAS; SAS) obtained through two separate audio inputs of the looper.

In an implementation of the disclosure the above method is implemented and executed in a musical looper according to a system of the disclosure.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, in which:

FIG. 1 illustrate a multiple audio track recording and playback system according to an implementation of the disclosure,

FIG. 2 illustrates a hardware schematic of a system or a device according to an implementation of the disclosure,

FIG. 3 illustrates a timing aspect of the playback and recording according to an implementation of the disclosure,

FIGS. 4A-4C illustrate aspects of playback according to an implementation of the disclosure,

FIG. 5 illustrates an optional user interface according to an implementation of the disclosure,

FIG. 6 shows a processing scheme according to an implementation of the disclosure,

FIG. 7 shows a complex spectral difference onset detection function (ODF) according to an implementation of the present disclosure, and

FIGS. 8A-8C illustrate different ways of establishing time references for playback within the scope of the disclosure.

### DETAILED DESCRIPTION

In the following description, certain specific details are set forth in order to provide a thorough understanding of various implementations of the disclosure. However, one skilled in the art will understand that the disclosure can be practiced without these specific details. In other instances, well-known processors, hand-held devices, computer systems and well-known structures and processes associated with these devices have not been described in detail to avoid unnecessarily obscuring the descriptions of the implementations of the present disclosure.

Unless the context requires otherwise, throughout the specification and claims that follow, the word “comprise” and variations thereof, such as “comprises” and “comprising,” are to be construed in an open, inclusive sense, that is, as “including, but not limited to.”

Reference throughout this specification to “one implementation” or “an implementation” means that a particular feature, structure, or characteristic described in connection with the implementation is included in at least one implementation. Thus, the appearances of the phrases “in one implementation” or “in an implementation” in various places throughout this specification are not necessarily all referring to the same implementation. Furthermore, the particular features, structures, or characteristics can be combined in any suitable manner in one or more implementations.

As used in this specification and the appended claims, the singular forms “a,” “an,” and “the” include plural referents unless the context clearly dictates otherwise. It should also be noted that the term “or” is generally employed in its sense including “and/or” unless the context clearly dictates otherwise.

As used in the specification and appended claims, the use of “correspond,” “corresponds,” and “corresponding” is intended to describe a ratio of or a similarity between referenced objects. The use of “correspond” or one of its forms should not be construed to mean the exact shape or size.

In the drawings, identical reference numbers identify similar elements or acts. The size and relative positions of elements in the drawings are not necessarily drawn to scale.

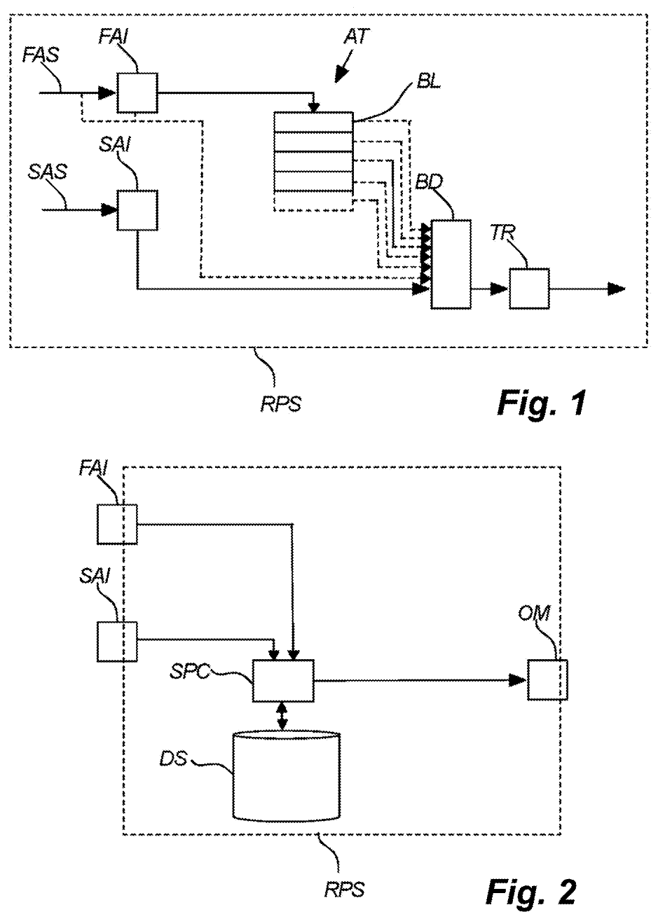

FIG. 1 illustrates the principles of a multiple audio track recording and playback system RPS.

The system may be implemented as a system of co-working modules or components, or it may be implemented as a stand-alone device.

The illustrated system RPS comprises two audio inputs, a first audio input FAI for receipt and recording of audio tracks AT representing the first audio stream FAS and a second audio input SAI for receipt of a second audio stream SAS.

The recorded audio tracks may be subject to playback on, e.g., a system output (not shown).

The system is configured for playback of the audio tracks AT recorded on the basis of the first audio stream FAS and the playback is performed with reference to a tempo reference TR.

The tempo reference TR is automatically derived from beats obtained through beat detection BD, and the system is configured for beat detection on the basis of at least the first audio stream FAS and the second audio stream SAS. It is indicated by the dotted line that the first audio stream FAS may be subject to direct beat detection, but the beat detection may, in principle, also be performed on the basis of recorded audio tracks.

This means that the system has been configured to perform beat detection BD on both the first audio stream FAS and the second audio stream SAS.

The performed playback of audio tracks may, thus, be affected by, or be dependent on, both the first and the second audio stream. The playback may not necessarily be dependent on both the first and second audio stream at the same time, but the playback must at least be subject to control of the playback tempo from the first and the second audio streams at different times. The present disclosure may, in principle, work with the recording of a single audio track, but it is preferred that the system is configured for recording and simultaneous playback of several audio tracks at the same time. The number of audio tracks may, in principle, be unlimited, but a practical use might typically be 8 to 16 audio tracks.

The recording of the audio tracks may be performed with the use of an appropriate user interface enabling the user to record the audio tracks on the basis of the first audio stream. The user interface may be more or less complicated, but it should at least enable a user to set at a starting point in time and an ending point in time for recording of a first audio track of a session.

FIG. 2 shows the hardware principles of a recording and playback system RPS according to an implementation of the disclosure. The illustrated system components may be incorporated and co-functioning in a device within the scope of the disclosure. The illustrated system may, e.g., be implemented according to the principles of FIG. 1.

The illustrated system RPS comprises an optional casing (not shown) and the system comprises two audio inputs, a first audio input FAI for receipt and recording of audio tracks AT representing the first audio stream FAS and a second audio input SAI for receipt of a second audio stream SAS. The principles of operation will be explained with reference to FIG. 1.

The system inputs are communicatively coupled with signal processing circuitry SPC. The signal processing circuitry SPC executes different algorithms suitable for the operation of the device. A beat detection BD process in relation to the first and second audio streams is continuously executed for the purpose of detecting beats and tempo in both input audio streams. The signal processing circuitry SPC is further configured for recording and playback of audio tracks AT on the basis of the first audio input FAS. The recorded audio tracks are stored for subsequent playback in a data storage DS.

The data storage may be distributed within the system or constitute a single data storage.

The signal processing circuitry SPC may also constitute one single device, or it may be distributed in co-working processors in the system.

The algorithms for execution by the signal processing circuitry are stored in the data storage DS.

The signal processing circuitry SPC is communicatively coupled to a system output mechanism (OM) for playback of recorded audio tracks AT.

The illustrated system may be configured as a single device, e.g., as a stomp box, but it may also be constructed as a number of interconnected hardware units. The connection may be wired or wireless. The user interface and a lot of the real signal processing may, thus, be included in an iPad or Android platforms. Such an application includes a drum machine on an iPad that “plays along” with the band to an extent. Other ways of configuring the system are to include it in an instrument, e.g., a keyboard interfaced with the proper required input and output. Microphones used for the input may be used both in relation to the first and the second audio input. Microphones may be included in the system formed as a single device, or the microphones may be coupled to the device by means of conventional wiring.

The number of microphones either connected to the system or included in the system may be as high as desired. Some applications would refrain from using microphones or microphone inputs in relation to the first audio input and simply use a plain instrument input, e.g., coupled with jack or XLR connectors.

The second audio input, which is primarily used for listening after suitable beats in the ambient sound, may include or be connected to, as many microphones as are required. This is particularly the case when directionality is desired for the purpose of enhancing or suppressing ambient sound from certain directions. In such a case, two or more microphones may be suitable, in the system or coupled to the system, in order to provide a second audio stream which is easier to handle when detecting beats and detecting beat confidence.

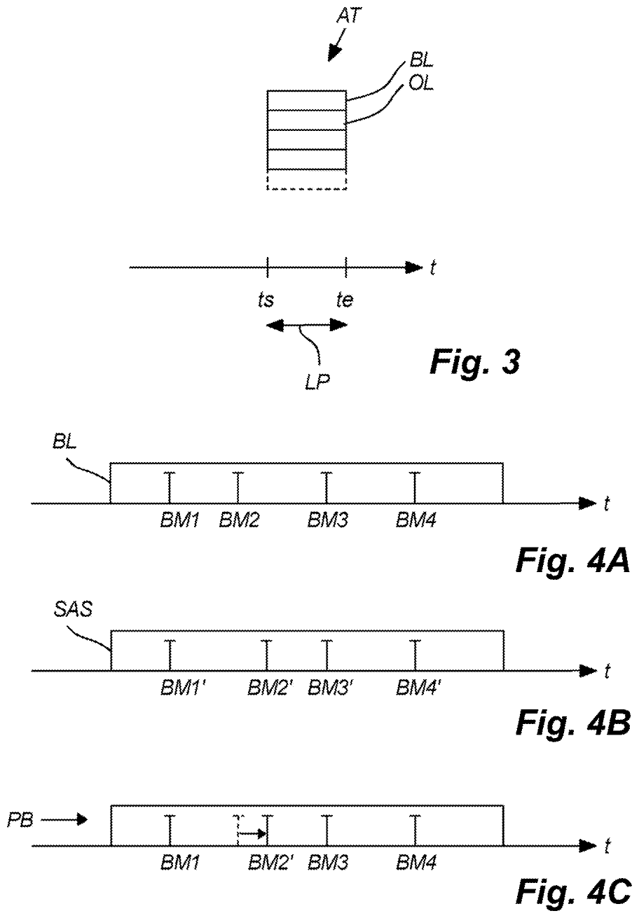

FIG. 3 shows some principles of playback and recording of the audio recorded on the basis of the first audio stream according to an implementation of the disclosure. The principles apply, as such, by themselves, but may be combined within any implementation of the disclosure disclosed herein, in particular the implementations of FIG. 1 or FIG. 2.

Multiple audio tracks AT are illustrated and indicate that a number of audio tracks have been recorded on the basis of the first input audio stream FAS. Algorithms stored in the data storage DS and executed by the signal processing circuitry SPC control the recording and subsequent playback of the audio tracks.

The number of recorded audio tracks AT may basically range from one to a desired number of overdub tracks, for example, 16.

The user may, thus, invoke a recording of an audio track AT having a starting time ts and an ending time te. The starting time ts and the ending time te may be established by a user, e.g., by means of a simple button(s) interface. The user may then explicitly or implicitly designate the recorded audio track as a base layer BL for a playback, looping the audio track to a system output.

The user interface may further be configured for recording of additional audio tracks AT, which may be referred to as overdub layers OL, and these layers may be played simultaneously with the base layer BL and be repeated during a loop period LP as defined by the starting time ts and the ending time te, which again may be defined by the base layer BL.

The set up and the initiation of the looping may be controlled by the user according methods well-known in the art.

The present principle, thus, relates to the setup of the looping, whereas the previous figures are directed to how the looping is affected by the beat detection.

The illustrated audio loops may, according to the provisions of the disclosure, be subject to playback with reference to a tempo reference TR which may be supplemented by a detection of the location of beats in the first or the second audio stream.

FIGS. 4A-4C illustrate implementations of the disclosure according to which a playback of the audio tracks are recorded and played back. The illustration is extremely simplified, but illustrates the meaning of a very advantageous implementation of the disclosure.

FIG. 4A shows that a recorded base layer BL is subject to beat detection, and four beats are identified in the base layer as beat markings BM1, BM2, BM3, and BM4. The beat marks are, thus, basically defined or derived from the first audio input which has been used for establishment of the base layer. The beat marks can also be the beats detected from the ambient signal while the loop was recorded.

Four beats are showed for the purpose of explanation. Other numbers and other ways of using the beats as a tempo reference for the playback specifically illustrated here may, of course, be possible within the scope of the disclosure.

Further audio tracks, e.g., overdubs, may be recorded and played back simultaneous in a mixed version on the system output (not shown in the present implementation).

Subsequently, when looping, beat detection may follow the first audio stream, in particular when being recorded, and beat detection may be performed. This beat detection may then be used as a tempo reference for a playback of all the audio tracks, the base layer, and the overdub layers.

Alternatively, within the scope of the disclosure, a beat detection related to the second audio stream SAS may be utilized as a means for controlling the tempo, and even the location of the individual beats if so desired of the looped audio tracks.

In FIG. 4B, a beat detection is performed on a second audio stream which is, in principle, not related to the recorded audio tracks but could be obtained, for example, from a microphone recording, e.g., percussive material, with beat detections having a high confidence.

These beats are detected to be located at times BM1′, BM2′, BM3′, and BM4′.

The detected beats may then, in real-time, be applied for modification of the base layer as illustrated in FIG. 4C, where the beat marking detected in the base layer BM2 is modified and moved on the time axis while using time stretching, known in the art in order to preserve pitch, while modifying a playback PB of the base layer so that the illustrated beat 2, BM2 of the base layers, is now delayed somewhat under the control of the beat BM2′ detected in the second audio stream SAS as illustrated in FIG. 4B.

The time synchronization between the second audio stream SAS and the time modified playback of the base layer and optional overdub layers, with reference to the same tempo reference, provides an effective and dynamic looping.

It should be noted that the illustrated beat detection indicates a strict beat to beat correction. It is generally, within the scope of the disclosure, preferred that the beat, if not corrected to exact locations of the controlling audio stream, is at least synchronized with respect to tempo. A tempo may, within the scope of the disclosure, be calculated as beats per minute (BPM), and a playback of the recorded track will generally have to fit the tempo of the controlled audio stream, but it may also be possible, as illustrated, that the individual beats of the recorded track, e.g., the base layer BL markings BM1-BM4, match so that the beat period matches the averaged beat period of the controlling audio stream.

Again, it should be noted that the controlling audio stream may be both the first and the second audio streams within the scope of the disclosure.

It should be emphasized that neither the first nor second audio stream, nor the related beat and tempo detection, is regarded as a tempo reference within the scope of the disclosure before it is actually used as a tempo reference for playback. A tempo reference TR may, thus, at one replay of a loop, be based on beat detection from the first audio stream and at another loop, e.g., a subsequent loop, the tempo reference TR may be based on another, a second, or an even further audio stream. The tempo reference may also be derived from the first and second audio streams or from further audio streams at the same time. The beat detection should typically be made all the time in relation to both or all audio streams, but it goes without saying that if the switching between source for beat detection intended for tempo reference is performed manually under the control of the user, such simultaneous beat detection on both streams may be avoided to save processing power. It would nevertheless also be within the scope of the disclosure, in relation to such manual switching, to continue beat detection on both audio streams and visualize to the user whether the beat detection is considered stable or not, and then make it up to the user to switch between the current source of beat detection and the resulting derived tempo reference.

Such switching may, of course, also be performed automatically within the scope of the disclosure. The switching may be more or less strict in the sense that it may be performed macroscopically, e.g., to cover a whole loop period, or the switching may be more detailed and instead be understood as a tempo reference which is derived and combined from the individual beats of each involved input audio stream.

In an exemplary implementation of the disclosure, the listening looper is based on an algorithm that samples the live audio in a performance space and applies both time and frequency domain analysis to discern periodic energetic peaks (beats) in the music. An interpolative function is applied to estimate the time interval between the most recent peak and the peak(s) that came before the most recent peak. This interval is defined as the beat period. The beat period is translated into a beats-per-minute (BPM) estimate, and the recorded loop playback tempo is adjusted to match the BPM value estimated by the algorithm. The algorithm also predicts the timing of an upcoming beat, so that the beat in the recorded loop can be aligned to match the predicted beat location. The algorithm listens to the ambient room sound while a loop is being recorded, predicts the tempo, and immediately applies it to loop playback through polyphonic time stretching, which allows the loop to follow the band without any changes in pitch or audible loss in sound quality.

The listening looper algorithm may be loaded into a stomp box-style piece of hardware which is intended to be used by guitar players, but could be likewise implemented by other musicians. The looper can be controlled with the player's feet in a similar fashion to other types of foot-controlled effects pedals. The stomp box design includes loop start/stop/record/overdub switch controls and level control to adjust loop volume relative to the dry instrument throughput.

An exemplary looper pedal is designed to be deployed in a live performance setting, typically by a guitar player, and ideally positioned such that it is in reasonably close proximity to the drummer, percussionist, or near a monitor that provides reliable playback from the percussive source.

The looper is designed to detect the percussive source in the room, identify beat candidates from the percussive source, and derive a tempo in BPM by actively listening to the source. An integrated beam forming technology in a two-microphone array integrated in the looper provides additional improved beat detection in relation to the second audio stream received and channeled through the microphones. The improvement in this beam forming technology is obtained through sound wave onset delay and the location of the guitar amplifier in the physical space, and reduces or eliminates the guitar amplifier output from the microphone signals so that it does not affect beat detection/tracking. Active, real-time functionality allows the looper to listen to the band, identify and isolate the tempo from other non-rhythmic audio sources, and dynamically adjust loop playback to match the band's tempo and beat.

In typical operation, the guitarist plugs into the listening looper pedal, and the input signal from the guitar is fed into a digital signal processing chain that includes a microprocessor, analog-to-digital converter, and audio codec, in addition to memory to store recorded loops. A normal looping pedal would provide simple record and playback controls. The disclosed disclosure may integrate pre-processed ambient audio into the signal processing chain, from which a live tempo may be derived and used as the playback tempo for the recorded loop.

The looper is controlled via a footswitch, with optional extended control features implemented with rocker switches and potentiometers. The disclosed description is based on a two-footswitch implementation using press and press-and-hold control to start, stop, record, and overdub loops. Other ways of implementing the switch configuration may, of course, be applicable within the scope of the disclosure, e.g., by using dedicated switches for start, stop, record and overdub. The player using this looper would start the recording sequence, play a musical phrase lasting for an arbitrary number of measures, and then cue the playback feature, which accesses the most recent BPM estimate and plays the loop at that tempo. Information regarding the current state of the looper is displayed to the guitarist using a pair of RGB LEDs. According to a very advantageous implementation of the disclosure, it is also possible to quantize the loop so that the start and the end of a loop align with a beat mark or at least so that the detected loop beat marks are fitting into beat mark periods between the repeated loops. In this way, a simple, extremely user-friendly establishment of a loop has been implemented, as many prior art loopers are extremely difficult to control for a musician, thereby creating irregular beat periods when the audio tracks are repeated.

Implementations of the present disclosure incorporate additional switches and potentiometers for expanded control, additional user control, additional display(s), and integration with other stomp box effects.

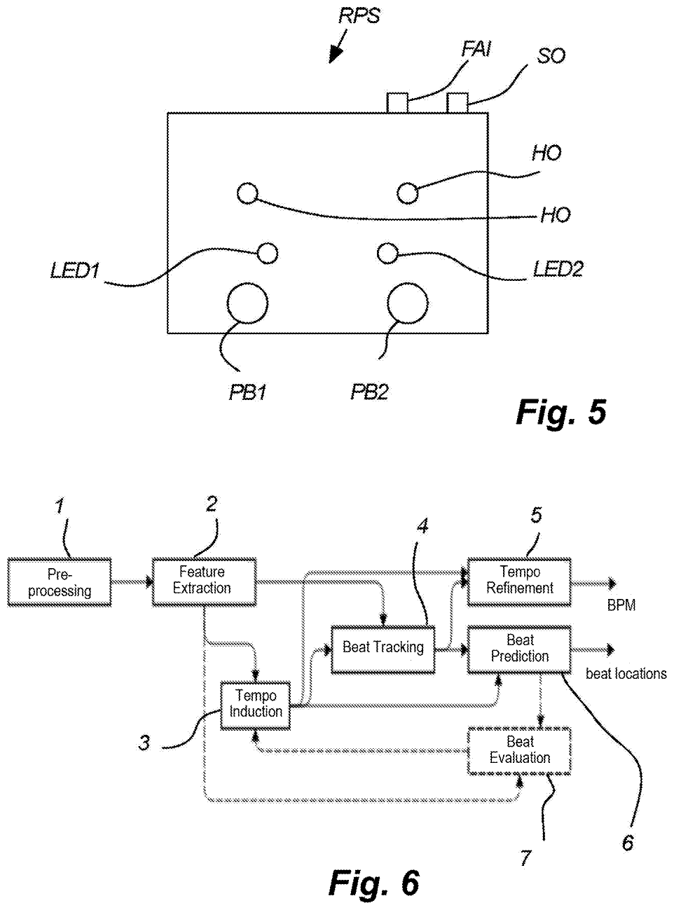

FIG. 5 shows an exemplary physical looping device RPS built into a cast metal chassis with foot-switchable controls to implement start/stop/loop/overdub features. The preferred implementation also features a switch to select between the listening looper function and the standard looping function, as well as a potentiometer to control the loop playback level relative to the standard guitar output level.

The device RPS includes a first audio input FAI and a system output SO.

The chassis has holes HO drilled through its top face to permit incoming sound from the room to reach an on-board microphone arrangement comprising two microphones (not shown). The microphones are omnidirectional electret capsules with a broad frequency response, selected in pairs for their matching gain and frequency characteristics.

The illustrated device further features two light emitting diodes, LED1 and LED2. Further display may, of course, be provided. The device DEV is configured by hardware to display the status of the looper pedal to a user as described below. Numerous other ways of providing the interface to the user are, of course, applicable within the scope of the disclosure.

TABLE 1

| | LED 1 | LED 2 |
|---|---|---|
| Off | No loop present | Beat tracking is off |
| Solid Green | Loop is playing | Assessing beat |
| Flashing Green | Loop present, | Steady (or tapped) beat |
| (Flashing is in | ready to play | detected and locked |
| sync with beat) | | |
| Solid Red | Recording/Overdubbing. | Ambient microphone |
| | | signals contain too |
| | | much of the looper |
| | | output; it may mask |
| | | the other rhythm |
| | | sources and affect the |
| | | beat tracking accuracy |
| Flash Green/Red | Manually triggered | Manually triggered |
| | detection of guitar amp | detection of guitar |
| | direction | amp direction |

The device RPS further comprises two push-buttons, PB1 and PB2, for control of the looper. The control includes resetting the looper to start up a new session SES for the purpose of recording a new base layer BL on the basis of the first audio stream FAS, initiating and defining a base layer and, thereby, defining the loop period. The control includes also adding or removing overdub layers and bypassing/stopping the looping. Other suitable controls may be included in the device.

### Function/Implementation

FIG. 6 illustrates an important function of the exemplary listening looper, which is to evaluate the tempo and timing of the beats of an incoming signal via a simple array of two omnidirectional microphones, as indicated in relation to FIG. 5, which are placed at a guitarist's feet, ideally in close proximity to, or in an unobstructed path between, the guitarist and the drummer or percussionist in the group. The exemplary listening looper algorithm features a series of states in which the incoming information via the microphone array is evaluated: pre-processing 1, feature extraction 2, tempo induction 3, beat tracking 4, tempo refinement 5, beat prediction 6, and beat evaluation 7, which are further explained below. The illustrated looper algorithm is also aided in its function through beam forming with multiple microphones, time scale modification, and beat marking in the recorded loop, as explained in relation to FIGS. 4A-4C.

Signal pre-processing 1: The input signal, the second audio stream SAS at the microphones, is sampled at 48 kHz, then decimated by a factor of 4, down to 12 kHz.

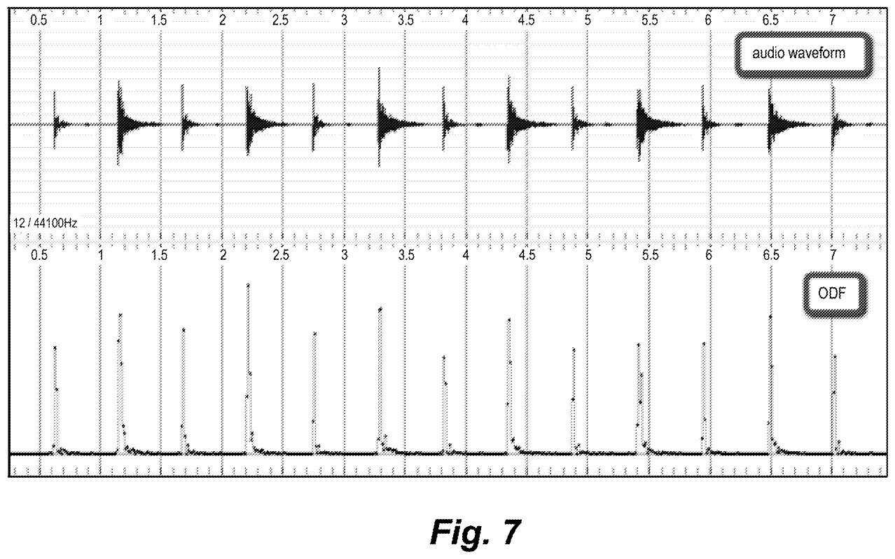

Feature Extraction 2: The input feature for the beat tracking system is the complex spectral difference onset detection function (ODF)—a continuous midlevel representation of an audio signal which exhibits peaks at likely note onset locations. This function takes into account changes in phase and magnitude, and seeks to emphasize note or beat onsets which are taken to be represented by a significant change in magnitude or phase in the difference function. The onset detection function is calculated by measuring the Euclidian distance between an observed spectral frame and a predicted spectral frame (see FIG. 7) for all bins k, where:

$$Γ ( m ) = {\sum }_{k = 1}^{K} \vert {X}_{k} ( m ) - {\hat{X}}_{k} ( m ) \vert .$$

Tempo Induction 3: Accurate beat tracking requires that a set of tempo candidates are established prior to extrapolating the beat period. Since the speed of the live music performance intended to be tracked by the listening looper will vary continuously over time, it is necessary to regularly update the tempo estimate used by the beat tracking stage. In conjunction with the beat prediction methodology, the tempo is re-estimated after each new predicted beat has elapsed. For the sake of simplicity and computational efficiency, the preferred implementation uses one tempo candidate. Given sufficient computational space and speed, multiple tempo candidates can be introduced as a means to increase robustness, where each of the candidates generates a beat sequence to be weighed against the incoming data, which are in turn evaluated to choose the best tempo and beat candidate.

The approach and methodology adopted to estimate tempo can be summarized in the following steps:
1. Extract an analysis frame up to the current time (presently 6 seconds)
2. Preserve the peaks in the analysis frame by applying an adaptive moving mean threshold to leave a modified detection function
3. Take the autocorrelation function and apply a Gaussian perceptual weighting function:

$$TPS ( τ ) = W ( τ ) {\sum }_{t} O ( t ) O ( t - τ )$$

$$where$$

$$W ( τ ) = exp \{ - \frac{1}{2} {( \frac{{log}_{2} τ / {τ}_{0}}{{σ}_{τ}} )}^{2} \}$$

4. If the time signature is known, a down-sampled (by number of beats per bar) version of the autocorrelation function is added to the original autocorrelation function.
5. The highest peak in the modified autocorrelation function is chosen as the tempo candidate and a quadratic peak interpolation on the original autocorrelation is applied to increase the peak resolution
6. Multiband (2 to 4) spectral flux readings are applied for tempo estimation and beat location estimation.

Beat Tracking 4: The underlying model for beat tracking assumes that the sequence of beats will correspond to a set of approximately periodic peaks in the onset detection function and follows the dynamic programming approach described in the ODF and tempo induction calculations. The core of this method is the generation of a recursive cumulative score function (RCSF) whose value at moment m is defined as the weighted sum of the current ODF value and the value of C at the most likely previous beat location:

$${C}^{*} ( m ) \vert = m ( 1 - α ) Γ ( m ) + α {max}_{υ} ( {W}_{1} ( υ ) C ( m + υ ) ) .$$

The RCSF is applied to search for the most likely previous beat over the evaluated interval from −2 bp to −0.5 bp into the past, where bp specifies the beat period, i.e., the time in ODF samples between beats. The greatest weight is given to the ODF sample that is exactly 1 bp in the past, W1 is a log-Gaussian transition weighting:

$${W}_{1} ( υ ) = exp ( \frac{- {( η log ( - υ / {τ}_{b} ) )}^{2}}{2} )$$

Beat tracking 4 is further refined by simple beat prediction, where the upcoming location is chosen as the last beat location plus the estimated beat period, or dynamic programming beat prediction, which is achieved by continuously computing the cumulative score with the weight\alpha=0 for 1.5 times the beat period, then selecting the highest peak in the predicted/extrapolated cumulative score.

Tempo Refinement 5: The tempo obtained from the tempo induction stage is imprecise because of the poor time resolution. The final BPM estimate is derived from the estimated beat locations in the ODF domain. Greater precision is obtained with a recursive look at the time domain signal.

Tempo refinement is also implemented with a two-state solution. The general state uses a 6 second analysis window to locate beat candidates and locations. When the looper is in a stable state, with a steady tempo established, computations are taken from a shorter history and narrower BPM range, which permits faster adaptation to tempo changes.

Beam Forming with Multiple Microphones: A two microphone array is used to enhance or reduce sound that comes from a particular direction. In the listening looper application, microphone signals are contaminated, e.g., with guitar amplifier output, and an implementation of the disclosure aims at reducing or eliminating the guitar amp output from the microphone signals so that it does not interfere with beat detection from rhythmic sources.

The effectiveness of the beam forming technique is limited by three major requirements:
1. Satisfy the far-field assumption. The far-field assumption is valid if the distance between the speaker and reference microphone is greater than 2*D2/λmin, where λmin is the minimum wavelength in the source signal and D is the array aperture.
2. Microphones must be omni-directional and must have very similar output levels. Together with the far-field assumption, this ensures that the sound waves arriving at the microphones only have timing differences, and very similar levels.
3. Microphone spacing will affect the effective frequency range and angular resolution.

This disclosure is intended to reduce the guitar amp signal in the microphones so that it does not bury the rhythmic source. The spacing between the two microphones on the pedal is set to satisfy the far-field requirement and the frequency spectrum of interest in a musical context.

Polyphonic Time Scale Modification: A high quality polyphonic time scale modification algorithm has been designed to adjust the tempo of the recorded loop in real time without affecting the pitch. This algorithm is also used during recording of the overdub loop layer so that it will align with the base loop layer, thus providing real-time, multi-track time stretching.

Beat Marking of the Recorded Loop: During loop recording, if there are steady beats being detected by the beat tracking algorithm, the beat locations determined by beat tracking are stored as the beats of the loop; when steady beats from microphone inputs are not available, the beat tracking algorithm is applied to the recorded loop to determine the location of beats in the loop.

Advantageous features of implementations of the disclosure include, but are not limited to:
(1) the listening algorithm being implemented using two omnidirectional “room sense” microphones that actively listen to the ambient sound in the space, specifically seeking to identify and, if possible, isolate drums and percussive rhythmic elements that typically indicate energetic peaks which, in turn, signify the location, in the time domain, of the beats and beat period in the music being performed;
(2) the beat tracking feature in the listening looper being enhanced with the implementation of beam forming technology, which seeks to identify the direction of arrival (DOA) of incoming sound from a guitar amplifier or other non-rhythmic contaminant sound sources, which would tend to bury the rhythmic source or make beat candidate identification more difficult;
(3) the two room sense microphone array being spaced such that the sound waves arriving at the microphones can be separated by their proximity to the incoming sound source;
(4) the beam forming algorithm estimating the phase differences of incoming sound sources between the two microphones and identifying the DOA of the guitar amplifier or the DOA of the dominant rhythmic source, usually the drums, the goal being to reduce the signal from the guitar amplifier or enhance the rhythmic source using the principle of destructive or constructive interference, thereby providing a cleaner stream of reliable beats for analysis by the tempo tracking algorithm; and
(5) the combination of beat tracking with beam forming and time stretching, being implemented in a stomp box, can be used on-the-fly with no additional gear or software, which is an entirely new way to create loops in a live music situation.

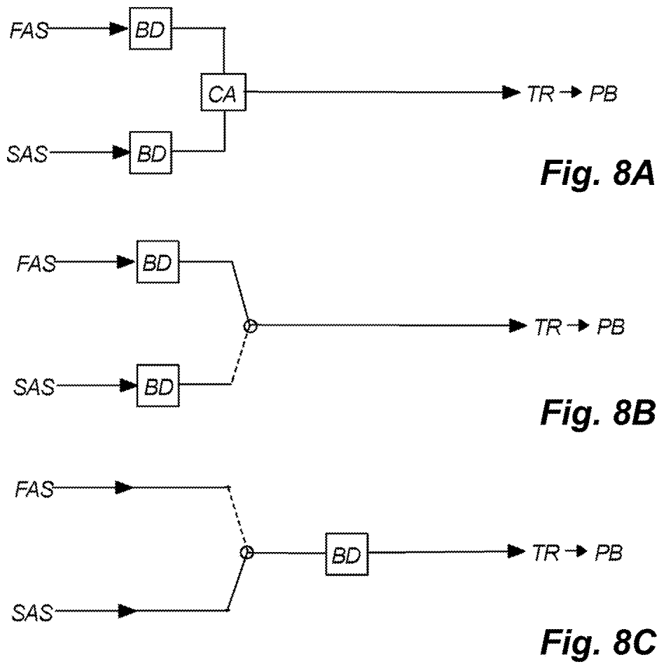

FIGS. 8A-8C illustrate some principle features according to the disclosure in relation to the tempo reference TR. The illustrated methods represent a few of the many different implementations within the scope of the present disclosure.

FIG. 8A illustrates that a beat detection BD is performed on the basis of the first audio stream FAS, be it on the first audio stream as such or on some converted representation of the audio stream, e.g., a beat detection performed on the recorded audio tracks of the first audio stream.

A further beat detection BD is performed on the basis of the second audio stream SAS. Also here, the beat detection may be performed on the second audio stream as such or on some converted representation of the audio stream.

A confidence algorithm CA is then applied for automatic establishment of a confidence estimate related to the two-input audio stream, and the algorithm will automatically establish a tempo reference TR on the basis of the most suited audio steam, the first audio stream, the second audio stream, or a weighted combination of the audio streams. The weighting may be on a beat-level.

The playback of recorded audio tracks is then based on the established tempo reference TR. If the tempo of the used audio stream source(s) for beat detection goes up, the tempo of the playback of the recorded audio tracks also goes up, and vice versa when the tempo of the used audio stream source goes down.

FIG. 8B illustrates that a beat detection BD is performed on the basis of the first audio stream FAS, be it on the first audio stream as such or some converted representation of the first audio stream, e.g., a beat detection performed on the recorded audio tracks of the first audio stream. A further beat detection BD is performed on the basis of the second audio stream SAS. Also here, the beat detection may be performed on the second audio stream as such or on some converted representation of the audio stream.

In this implementation manual switching is applied, e.g., switching is established by means of a suitably arranged user interface (not shown). FIG. 8C illustrates an implementation where manual switching is performed between the first and second audio stream. In this implementation, the beat detection will only be performed on the selected audio stream, here the second audio stream SS.

It should be emphasized that tempo reference according to the present disclosure includes an averaged tempo over a number of beats. A tempo reference TR may, in such an implementation, just simply adjust the tempo of the playback.

According to a preferred variant within the scope of the disclosure, the tempo reference TR may also constitute a more direct control of the individual beats of the playback, i.e., a more specific weighing between the two audio streams performed in relation to specific beats of the two (or more) audio streams. The playback may, thus, be adjusted to synchronize to selected beat locations, interpolated locations, etc. A beat-per-beat control will, of course, also provide a tempo reference within the terms and definition of the disclosure as playback of the audio tracks on the basis of such tempo reference (control of the basis of individual beats) will eventually result in a modified tempo of the playback.

As for the confidence estimate established by the confidence algorithm CA, the confidence may be measured by how much the music has repeated itself in the measurement window (e.g., 6 seconds). For example, a rhythm guitar part would have strong repeating patterns or a straight drum line. Solo guitar riffs may not be very good sources for indications of beats. Another layer of confidence relates to how similar the ambient signal, the second audio stream, is to the system output. A high level of similarity means that the ambient signal does not contain the band, so it is time to use the instrument, the first audio stream.

The detection of beats and the establishment of a related tempo reference may, in some instances, prove difficult.

In an implementation of the disclosure, the system detects beats from downbeats only. These are the “one-two-three-four” beats. Most types of music are based on these. However there are styles within music genres, and indeed individual songs, where the driving pulse of the music features less of these and more of the “one and, two and-ah, three-eee and ah” beats. If enough of these off-beats or syncopations are played, an algorithm strictly detecting tempo on these may become confused and derive incorrect tempo detection.

In an implementation of the disclosure, this problem may be dealt with as described below:
the band plays, the user sees on the product display that the tempo is incorrect, and the user taps beats as hints at the correct beats, even though the bass drum or driving tempo reference may not have beats at those points; and
the algorithm looks at where the user tapped and where energy pulses fall before or after those beats and forms a basis for ongoing tempo deductions; this hinting makes it easier for the algorithm to detect the true beat, as the algorithm will now know where to look in particular.

Such syncopation or tempo profiles may be established on the fly, but they may also be stored on the product to call up in later performances.

In an implementation of the disclosure the system may have tempo profiles stored and wirelessly communicate with the cloud where they are stored and, in turn, downloaded to the units as gained knowledge to improve performance of all units.

### Implementations:

The various implementations further can be implemented in a wide variety of user environments, which in some cases can include one or more user smart phones, personal tablets or processing devices which can be used to operate any of a number of applications. User or client devices can include any of a number of general purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include any electronic device that is capable of communicating via a network.

Most implementations utilize at least one network that would be familiar to those skilled in the art for supporting communications using any of a variety of commercially available protocols, such as Transmission Control Protocol/Internet Protocol (“TCP/IP”), Open System Interconnection (“OSI”), File Transfer Protocol (“FTP”), Universal Plug and Play (“UPnP”), Network File System (“NFS”), Common Internet File System (“CIFS”), and AppleTalk. The network can be, for example, a local area network, a wide-area network, a virtual private network, the Internet, an intranet, an extranet, a public switched telephone network, an infrared network, a wireless network, and any combination thereof.

In implementations utilizing a Web server, the Web server can run any of a variety of server or mid-tier applications, including Hypertext Transfer Protocol (“HTTP”) servers, FTP servers, Common Gateway Interface (“CGI”) servers, data servers, Java servers, and business application servers. The server(s) also may be capable of executing programs or scripts in response to requests from user devices, such as by executing one or more Web applications that may be implemented as one or more scripts or programs written in any programming language, such as Java®, C, C #, or C++, or any scripting language, such as Perl, Python, or TCL, as well as combinations thereof. The server(s) may also include database servers, including without limitation those commercially available from Oracle®, Microsoft®, Sybase®, and IBM®.

The environment can include a variety of data stores and other memory and storage media as discussed above. These can reside in a variety of locations, such as on a storage medium local to (and/or resident in) one or more of the computers or remote from any or all of the computers across the network, public cloud capable, and hybrid compute cloud. In a particular set of implementations, the information may reside in a storage area network (“SAN”) familiar to those skilled in the art. Similarly, any necessary files for performing the functions attributed to the computers, servers, or other network devices may be stored locally and/or remotely, as appropriate. Where a system includes computerized devices, each such device can include hardware elements that may be wirelessly coupled via a Wi-Fi, the elements including, for example, at least one central processing unit (“CPU”), at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (“RAM”) or read-only memory (“ROM”), as well as removable media devices, memory cards, flash cards, etc.

Such devices also can include a computer-readable storage media reader, a communications device (e.g., a modem, a network card (wireless or wired)), an infrared communication device, machine-readable code, QR codes, etc.), and working memory as described above. The computer-readable storage media reader can be connected with, or configured to receive, a computer-readable storage medium, representing remote, local, fixed, and/or removable storage devices, as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or Web browser. It should be appreciated that alternate implementations may have numerous variations from that described above. For example, customized hardware might also be used, and/or particular elements might be implemented in hardware, software (including portable software, such as applets), or both. Further, connection to other computing devices such as network input/output devices may be employed. The use of QF codes will be important as it will leverage other users' experience in order to identify and track progress and movement—including sponsor businesses.

Storage media computer-readable media for containing code, or portions of code, can include any appropriate media known or used in the art, including storage media and communication media, such as but not limited to volatile and non-volatile, removable and non-removable media implemented in any method or technology for storage and/or transmission of information such as computer-readable instructions, data structures, program modules, or other data, including RAM, ROM, Electrically Erasable Programmable Read-Only Memory (“EEPROM”), flash memory or other memory technology, Compact Disc Read-Only Memory (“CD-ROM”), digital versatile disk (DVD), or other optical storage, magnetic cassettes, magnetic tape, magnetic disk storage, or other magnetic storage devices, or any other medium which can be used to store the desired information and which can be accessed by a system device. Based on the disclosure and teachings provided herein, a person of ordinary skill in the art will appreciate other ways and/or methods to implement the various implementations.

The various implementations described above can be combined to provide further implementations. These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A multiple audio track recording and playback system (RPS), comprising:
a first audio input for receipt and recording of audio tracks AT representing a first audio stream; and
a second audio input for receipt of a second audio stream;
wherein the system is configured to playback audio tracks recorded on the basis of the first audio stream and wherein the playback is performed with reference to a tempo reference, and
wherein the tempo reference is automatically derived from beats obtained through beat detection, and wherein the system is configured for beat detection on the basis of at least the first audio stream and the second audio stream.

2. The multiple audio track recording and playback according to claim 1, wherein the system is configured to playback audio tracks recorded on the basis of the first audio stream and wherein the playback is performed with reference to the tempo reference and location of the detected beats.

3. The system according to claim 1, wherein the system is configured to mark detected beats of at least one of the recorded audio tracks, thereby establishing a beat reference related to the relevant audio track.

4. The system according to claim 1, wherein the playback performed with reference to a tempo reference involves that recorded audio tracks are synchronized to the first or the second audio stream by means of time stretching.

5. The system according to claim 1, wherein the multiple audio track recording and playback system comprises a system output for playback of recorded audio tracks.

6. The system according to claim 1, whereby the system is configured to record audio tracks via the first audio input and wherein the recording is performed according to a user controlled looper algorithm implemented by computing hardware of the system, the looper algorithm enabling a recording of an audio track and designating this audio track functionally as a base layer, the looper algorithm further enabling the recording of a further audio track via the first audio input and designating this further audio track functionally as an overdub layer, the looper algorithm further enabling simultaneous playback of both the base layer and the overdub layer.

7. The system according to claim 1, wherein the first audio input is provided as an instrument input.

8. The system according to claim 1, wherein the second audio input is provided as input for ambient sound.

9. The system according to claim 5, wherein the system is configured as a stand-alone device comprising the first audio input, and wherein the device further comprises an on-board microphone arrangement communicatively coupled with the second audio input and wherein the device further comprises the system output.

10. The system according to claim 9, wherein the microphone arrangement is directional and where the microphone arrangement is communicatively coupled with signal processing circuitry of the device and wherein the signal processing circuitry is configured to enhance or suppress sound from a certain direction.

11. The system according to claim 1, wherein the source for beat detection is partly the first audio stream and partly the second audio stream and/or where the second audio stream serves as the primary source for beat detection.

12. The system according to claim 1, wherein the system comprises a user interface configured to manually switch between the first audio stream, or a signal derived therefrom, and the second audio stream as the principle source for automatic beat detection.

13. The system according to claim 1, wherein a confidence algorithm automatically establishes a confidence estimate related to the first audio stream and the second audio stream and wherein the tempo reference is automatically derived from the audio stream on the basis of the established confidence estimate.

14. The system according to claim 1, wherein the tempo of playback is established on the basis of beat detection of both audio recorded by the first audio input and audio received via the second audio input during playback.

15. The system according to claim 1, wherein the system comprises a user interface configured to enable user determination of a loop period, and wherein this loop period is preferably defined by a setting the period of the base layer.

16. The system according to claim 1, wherein the system further comprises a display arrangement through which quality of the beat detection in relation to the first and second audio stream is indicated visually.

17. The system according to claim 1, wherein the system comprises a MIDI output, and wherein the MIDI signal fed to the MIDI output reflects the current tempo reference.

18. The system according to claim 1, wherein the system comprises at least one further audio input to receive a further audio stream and whereby the tempo reference is based on of the first audio stream, the second audio stream and the at least one further audio stream.

19. A method of establishing a variable tempo of a musical looper, the method comprising: performing playback of the looper with reference to a tempo reference, the tempo reference being variable and dependent on beat detection performed with reference to at least two separate audio streams obtained through two separate audio inputs of the looper.

20. The method of establishing a variable tempo of a musical looper according to claim 19, wherein the method is implemented in a system comprising:
a first audio input for receipt and recording of audio tracks AT representing a first audio stream; and
a second audio input for receipt of a second audio stream;
wherein the system is configured to playback audio tracks recorded on the basis of the first audio stream and wherein the playback is performed with reference to a tempo reference, and
wherein the tempo reference is automatically derived from beats obtained through beat detection, and wherein the system is configured for beat detection on the basis of at least the first audio stream and the second audio stream.
